(19) United States
(12) Patent Application Publication
(10) Pub. No.: US 2006/0194913 A1
(43) Pub. Date: Aug. 31, 2006

(54) Method for production of a blend made with pvc

(76) Inventors: Jean-Pierre Pleska, Brussels (BE); Jean-Marie Yernaux, Rixensart (BE); Jean-Raphael Caille, Brussels (BE)

Correspondence Address: CONNOLLY BOVE LODGE & HUTZ, LLP, P O BOX 2207, WILMINGTON, DE, 19899, US

(21) Appl. No.: 10/548,131

(22) PCT Filed: Mar. 10, 2004
(86) PCT No.: PCT/EP04/02509

§ 371 Date: Jan. 9, 2006

(30) Foreign Application Priority Data
Mar. 10, 2003 (FR) 03/03029

(51) Int. Cl. C09B 67/00

(52) U.S. Cl. 524/502

(57) ABSTRACT

Process for manufacture of a blend based on PVC and at least one plastic, according to which: 1. the PVC and the plastic are dissolved in a common solvent; 2. joint precipitation of the PVC and of the plastic is brought about in the form of particles of blend, by injecting a common non-solvent into the solution; 3. the particles of blend are recovered.

The present invention relates to a process for the manufacture of a blend based on PVC, and to the blends which can be obtained by this process.

Plastics are widely used for the manufacture of various articles, flexible or rigid, in numerous application sectors, such as motor cars, electrical engineering, etc.

One of the most commonly used plastics is PVC (polyvinyl chloride). However, certain properties of this material can be improved, examples being its impact resistance, its processability, its heat resistance, and its mechanical strength and/or chemicals resistance, etc. One of the possible ways to achieve this improvement consists in mixing, with PVC, at least one polymer having the property or properties desired. The mixture obtained (whether homogeneous or non-homogeneous) is generally called a blend.

In the manufacture of blends from plastics, the technique most used on an industrial scale is mixing in the melt, while the technique of precipitation from a solution is mainly used in the laboratory (RAPRA REVIEW REPORTS, Vol. 5, No. 1, 1991, Blends and Alloys of Engineering Thermoplastics, H. T. van de Grampel, p. 16).

The dissolution of PVC and of EVA or of EMA in THF, and the subsequent precipitation from the solution by misting into methanol (in 10-fold excess, based on THF) with stirring has therefore been described for laboratory experiments (Makromol. Chem., Macromol. Symp. 52, 105-111 (1991)). However, this technique is not extrapolatable to industrial scale, particularly because of the economic and environmental problems connected with the use of large amounts of solvents, and the cost of the equipment needed to obtain a product of acceptable particle size (injection nozzle or misting nozzle in particular).

In contrast, the present invention provides a simple, cost-effective process which readily permits reclaim of the liquids (solvent and non-solvent) used and which also permits manufacture of blends based on PVC in finely divided form, with regular particle size particularly well suited to certain applications.

The present invention moreover provides a process for manufacture of a blend based on PVC and at least one other plastic, according to which:

1. the PVC and the plastic are dissolved in a common solvent;

2. joint precipitation of the PVC and of the plastic is brought about in the form of particles of blend, by injecting a common non-solvent into the solution;

3. the particles of blend are recovered.

“PVC” is understood to be any homo-or copolymer containing at least 50% by weight of vinyl chloride. The plastic according to the present invention is any plastic (thermoplastic or thermoset, homopolymer or block copolymer or random copolymer, etc.) which is not PVC, but which is soluble in at least one solvent (or mixture of solvents) for PVC. “Plastic” is understood to be a polymer with sufficient molecular weight to be a solid and to take the form of a solid object (having intrinsic mechanical strength) up to a temperature of at least 50° C. It is clearly understood that plasticizers and other additives usual in plastics (which do not themselves have intrinsic mechanical strength) can be present in the said plastic as well as, moreover, in the PVC. The material may also be a mixture of plastics complying with this same criterion. However, the present invention preferably provides binary blends based on PVC and a plastic.

Both the PVC and the plastic may be virgin resins never subjected to processing by melting. Alternatively, they may be used resins (i.e. having been previously subjected at least once to processing by melting, for instance production waste, recycled resins, etc.), possibly present within the same finished article. In this case, the article in question will generally be reduced to fragments of reduced size which are easier to handle, before being processed in the process according to the present invention. The average size of these fragments is preferably at least 2 cm. It is also advantageously at most 30 cm. Clearly, if the product already has the form of fragments of appropriate dimensions, the comminution step is superfluous.

The nature of the plastic may be chosen as a function of the property or properties whose improvement is desired. Examples of the choice of a resin are therefore:
ABS (acrylonitrile-butadiene-styrene), generally permitting improvement of impact resistance of the blend based on PVC, and/or its heat resistance, and/or its processability
polyurethane (PU), generally permitting improvement of impact resistance of the blend based on PVC, and its resistance to abrasion
polycarbonate (PC), generally permitting improvement of the heat resistance of the blend based on PVC, and/or its chemical resistance, and/or its transparency
polyester and in particular polyethylene terephthalate (PET), generally permitting improvement of resistance to UV of the blend based on PVC, and/or its heat resistance, and/or its processability
polystyrene (PS), generally permitting improvement of the heat resistance of the PVC, and/or permitting reduction of its viscosity in the melt and therefore permitting an increase in its suitability for injection moulding.

The process according to the present invention gives good results when the plastic is PS.

Alternatively, the choice of the plastic may be guided by the availability at low or zero cost of a source of supply of the said plastic. It may therefore be of interest to recover used plastics from certain sources, examples being PET bottles, mixtures derived from the electrical engineering and automotive industries, etc.

As mentioned above, “blend” is in fact understood to be either a homogeneous (monophasic) mixture or a heterogeneous (bi-or multiphasic) mixture of PVC and of the plastic(s).

The solvent capable of dissolving the PVC and the plastic simultaneously is preferably chosen from the liquids whose solubility parameter (a definition of which and experimental values are given in “Properties of Polymers”, D. W. Van Krevelen, 1990 edition, pp. 200-202, and in “Polymer Handbook”, J. Brandrup and E. H. Immergut, Editors, Second Edition, pp. IV-337 to IV-35) is close to the solubility parameters of PVC and of the plastic to be dissolved, and/or which has strong interactions with these (hydrogen bonds, for example). The term “close” is generally equivalent to “not differing by more than 6 units”. The material is generally an organic solvent, preferably polar, such as MEK (methyl ethyl ketone), which gives good results with a number of polymers and in particular with the halogenated polymers, such as PVC. The non-solvent is preferably chosen to have a solubility parameter markedly different from those of PVC and of the plastic to be dissolved, and so as not to have strong interaction with these materials. The term “different” is generally equivalent to “differing by more than 6 units”. Inorganic liquids are highly suitable non-solvents, and water is generally the preferred non-solvent (in the case of non-water-soluble polymers, of course) in view of the environmental and economic considerations generally involved in industrial processes. Water also has the advantage of forming an azeotrope with certain polar solvents such as MEK, and this can make it easier to remove the solvent by azeotropic distillation. Of course, solvent and non-solvent are understood to be either simple substances or mixtures of substances.

The dissolution process generally takes place under a pressure at least equal to atmospheric pressure, or at least equal to 1.5 bar. This pressure advantageously does not exceed 10 bar, preferably 5 bar.

The temperature of dissolution is generally at least 75° C., or 100° C.; it generally does not exceed 125° C., or 110° C.

It may moreover be advantageous to operate in an inert atmosphere, for example under nitrogen, in order to avoid any risk of explosion and of degradation of the solvent and/or of the non-solvent.

After or during the dissolution of the PVC and of the plastic, but prior to the precipitation of the particles of blend, one or more additives may be added to the solution. In this variant of the invention, “additive” is understood to be any inorganic or organic compound not present in the original plastics, or present in an amount below that desired. Inorganic additives which may be mentioned are inorganic pigments, carbon black, metallic powders, nanoparticles of various types, etc. Organic additives which may be mentioned are organic pigments, stabilizers, oligomers, etc. The process according to the present invention makes it particularly easy to introduce pigments and carbon black (particularly for antistatic grades) into the blends.

In the process according to the present invention, it can also be advantageous, according to the nature of the plastic, to introduce at least one additive comprising a compatibilizer for PVC and for the plastic.

A compatibilizer is understood to be any compound permitting reduction of the interfacial tension between the phases of the mixture, which generally consist respectively of PVC on the one hand and of the plastic on the other hand. These materials may be block copolymers, grafted copolymers or random copolymers, one of the constituents of which has a certain affinity (miscibility) with respect to PVC (NBR (or nitrile butadiene rubber), for example), while another has affinity (miscibility and/or reactivity) with respect to the plastic. The aim is to ensure good dispersion of one phase in the other phase, to ensure the stability of the morphology during processing, for example, and to improve the adhesion between the phases in the solid state in order to ease the transfer of stresses and thus improve the mechanical properties of the product. Ideally, the components of the compatibilizing copolymer consist of monomeric units which are the same as those of the polymers to be compatibilized, or at least of one of those polymers. Compatibilization of PVC/PS mixtures may therefore particularly be ensured by adding the following copolymers : poly(styrene-p-chlorostyrene), polystyrene-PMMA, polystyrene-PVAc, chlorinated poly(styrene-butadiene), poly((styrene-butadiene)-g-CHMA), where g=grafted and CHMA=cyclohexyl methacrylate, poly((styrene-butadiene)-g-MMA), and SAN (poly(styrene-acrylonitrile)). It should also be noted that compatibilization via reactive extrusion processes permits in-situ preparation of these compatibilizers by reaction between the constituents of the mixture during their processing.

The additives discussed above may be liquids or solids. These additives may be soluble or insoluble in the solution, but care will preferably be taken to obtain a homogeneous dispersion or solution by using adequate means and principally by using adequate stirring. This can be ensured by any known device, for example by a mechanical stirrer or by blowing in gas bubbles.

Once the PVC and the plastic have been dissolved, the precipitation of the blend is brought about by adding, to the solution of the PVC and of the plastic, a non-solvent whose amount is sufficient to bring about complete precipitation of the blend in the form of particles. This precipitation is advantageously achieved by injecting non-solvent conjointly in liquid form and in gaseous form, thus accelerating the precipitation of the blend. Without detriment, the non-solvent injected may possibly contain a low subordinate concentration of solvent; this is of interest to the extent that, as explained below, a possible subsequent step of the process may specifically provide a source of non-solvent such as can be reused without a particular purification.

The particles of blend are separated from the solvent/non-solvent mixture by any known means (evaporation, centrifuging, filtration, etc.) in the process according to the present invention.

In the context of the process according to the invention, it is advantageous for the solvent used to be miscible with the non-solvent and to form an azeotrope therewith. In this case, much of the solvent can be removed by evaporation from the precipitation medium in the form of vapour of azeotropic composition. The solvent is advantageously chosen from methyl ethyl ketone (MEK), methyl isobutyl ketone and tetrahydrofuran. The non-solvent is advantageously water. In the context of the invention, “water” means an aqueous medium whose ponderal content is mostly water (therefore containing more than 50% by weight, or more than 60%, and preferably more than 70% by weight). The material is advantageously pure water or water containing a subordinate amount (by weight) of solvent. The pairing MEK/water is preferably used, and forms an azeotrope comprising (at atmospheric pressure) 11% of water and 89% of MEK (by weight). The pairing MEK/water is particularly suitable.

According to one advantageous variant of the process according to the present invention, a phase separator compatible with the solvent and incompatible with the non-solvent is also present during the dissolution of the PVC and of the plastic in the solvent, and promotes this. The reason for this measure is that, given the cost of the reactants and the problems which could be caused by discarding them into the environment, it is desirable to treat the solvent/non-solvent mixture in order to reclaim each of its constituents separately. The addition of certain phase separators to the solvent/non-solvent mixture not only makes decanting from this mixture easier but also increases the dissolution capability of the solvent-rich phase with regard to PVC and/or the plastic. The result is that the process becomes more flexible, less energy-intensive, and less expensive.

The phase separator according to this variant of the invention is defined as a compound which promotes decanting from the solvent/non-solvent mixtures of PVC and the plastic. Given that it is compatible with the solvent and incompatible with the non-solvent, it is in essence absent from the phase rich in non-solvent derived from decanting from the mixture of the three compounds, and this can be advantageous if the non-solvent can be discarded into the environment (for example if this non-solvent is water), and also makes it easier to obtain a blend substantially free of the phase separator. The solubility parameter of the phase separator is preferably different from that of the PVC and of the plastic to be dissolved.

The amount of solvent (or of solvent/phase separator mixture) to be used has to be chosen in such a way as to avoid disruption of the smooth progress of the process (filtration, etc.) by the increase in viscosity brought about by the dissolution of the PVC and of the plastic. It is preferable that, during the dissolution step, the total amount of resins (PVC and plastic) does not exceed 300 g per litre of solvent and of any phase separator, preferably 200 g/l and in particular 100 g/l.

Phase separators with good suitability are aliphatic hydrocarbons having from 5 to 7 carbon atoms. Excellent results have been obtained by choosing n-hexane as phase separator.

With a view to reducing the size of the particles obtained by precipitation, it is advantageous that this precipitation takes place in the presence of a dispersing agent. From a practical point of view, the latter is advantageously added to the solvent during the dissolution of the PVC and of the plastic, and preferably as soon as it has begun. Alternatively, this dispersing agent may be added simultaneously with the non-solvent used for the precipitation process (either in the same stream or separately), but this procedure is more difficult to control and could lead to less homogenization of the medium. A “dispersing agent” according to this variant of the invention means a surfactant, such as bentonite, polyvinyl alcohol, gelatin, cellulosic ethers or esters, water-soluble (co)polymers, etc. Cellulosic ethers give good results. The amount of the dispersing agent used according to this variant of the invention is generally greater than or equal to 0.001% by weight, based on the weight of resins (PVC and plastic), preferably greater than or equal to 0.01%, or more preferably greater than or equal to 0.1%. The content of dispersing agent is generally less than or equal to 5%, or 2%, or more preferably 1%.

Another measure permitting reduction of the particle size of the product obtained is addition of the non-solvent progressively into the solvent containing the dissolved PVC and the dissolved plastic, and reduction of the pressure progressively below atmospheric pressure during the addition of non-solvent. The result generally observed is a phase inversion, i.e. the precipitation medium changes from a dispersion of the non-solvent in the solvent to a dispersion of the solvent in the non-solvent. This phenomenon is accompanied by a sudden fall in viscosity, and the precipitation of the blend in the form of grains of increasing density begins at that juncture. The reduction in pressure recommended above (and generally accompanied by a reduction in temperature) particularly advantageously takes place prior to the phase inversion, which therefore takes place at reduced pressure.

According to this advantageous variant of the present invention, the pressure is generally below or equal to 0.9 bar, or 0.8 bar, and preferably 0.7 bar during the phase inversion. This pressure is generally greater than 0.2 bar, or than 0.4 bar. Another advantage of a reduction in pressure during the progressive addition of non-solvent is that it can relax the critical threshold of concentration of resins at which the medium is seen to set. It therefore permits, as it were, treatment of a larger amount of PVC and of plastic, and therefore manufacture of a larger amount of blend with the same amount of solvent.

Finally, it is advantageous, in order to reduce the particle size to the maximum extent and to obtain a product free from agglomerates, to use a dispersing agent and simultaneously to reduce the pressure below atmospheric pressure during the progressive addition of non-solvent.

According to one preferred variant of the process according to the invention, the phase separator and the solvent are substantially removed from the precipitation medium by evaporation at a temperature below the boiling point of the non-solvent. This removal is rendered possible in particular by the choice of a solvent and of a phase separator having a boiling point below that of the non-solvent, and/or providing an azeotrope with the latter.

In certain cases, the vapours containing the solvent and the phase separator also contain a substantial fraction of non-solvent. These vapours are therefore advantageously condensed and subjected to decanting and subsequent removal of the phase rich in non-solvent prior to the reuse for dissolution of the plastic. This reuse may take place during a subsequent process, if the process of manufacture of blends is a batch process, or may be an integral part of the same process if the process is continuous. The phase rich in non-solvent resulting from the decanting process may also be reused during the precipitation of the blend, as already mentioned above. This phase generally consists of non-solvent saturated with solvent. If the solvent is MEK and the non-solvent is water, this phase is generally water comprising from 15 to 35% by weight of MEK and more commonly from 20 to 30% by weight of MEK.

A great advantage of the process according to the present invention is therefore that it can operate in a closed loop, without generating waste, given that both the phase containing the solvent and the phase separator and the phase containing the non-solvent can be recycled and reused in the process.

According to another advantageous variant of the process according to the present invention, the vapours containing the solvent and the phase separator are simply condensed and reused as they stand in the dissolution of the plastic, without prior decanting. This is advantageous when these vapours contain little non-solvent and/or when it is possible to operate at a diphasic equilibrium, with two phases (one phase rich in solvent and containing substantially all of the phase separator, since this is compatible with the solvent and incompatible with the non-solvent; and one phase rich in non-solvent). The phase rich in solvent then ensures, by correct choice of the concentrations of phase separator (needed to obtain the right solubility parameter), selective dissolution of the PVC and of the plastic. The phase rich in non-solvent does not disrupt this dissolution process. This is a great economic advantage of the process, since it thus permits saving of a separation step which is often energy-intensive and therefore expensive.

It is often advantageous to choose a batch process which proceeds in a loop with reclamation of the vapours containing the solvent (and possibly the phase separator), condensing and recycling of a fraction, or the entirety, of these vapours for the dissolution process in the following batch. Any phase separator is added at the first batch stage, or at the dissolution stage, or after condensation of the vapours. The second solution has given good results. Prior to the recycling (of a fraction) of the condensed vapours, it may be of interest to decant them, possibly using the phase separator, and to remove the phase rich in non-solvent. Alternatively, it is possible to recycle the entirety of the condensed vapours, with the proviso that the amount of phase separator used is appropriately modified. The reason for this is that the dissolution medium in this particular case contains a large amount of non-solvent and a sufficient amount of phase separator is needed to counterbalance the adverse effect of non-solvent on the dissolution of the PVC and of the plastic. With certain compounds, such as MEK (as solvent), water (as non-solvent) and n-hexane (as phase separator), two phases are observed to form during the dissolution process. In this case, since the total water content of the medium is generally at least 5% (by weight), it is also desirable to choose a hexane content of at least 5% (given that the remainder of the medium consists of MEK) in order to obtain an MEK-rich phase capable of dissolving the PVC and the plastic within an acceptable range of temperatures. It is preferably desirable that the water content does not exceed 15%, and this permits limiting of the hexane content to 30%.

The process according to the present invention also has the advantage of providing a product of fine and regular particle size in the form of fine round grains which can be used as they stand in certain applications, such as rotor moulding or slush moulding. Consequently, the present invention also provides a blend based on PVC and at least one plastic which can be obtained by the process described above, and consisting of substantially spherical particles having an average diameter (d) smaller than or equal to 800 μm, preferably smaller than or equal to 500 μm, or smaller than or equal to 400 μm, but generally greater than or equal to 100 μm; or greater than or equal to 150 μm. This blend also preferably has a breadth of distribution such that at least 80% of the particles have a diameter between d−0.4 d and d+0.4 d, or between d−0.3 d and d+0.3 d. It can therefore be used as it stands in applications which start from powder (slush moulding, for example), and does not have to be converted into powder by a suitable method (such as micronization), as is the case with the grains derived from traditional blend manufacture (in an extruder).

The following example provides a non-limiting illustration of the present invention:

A proportion of 25% by weight (based on the total weight of polymers) of PS (Lacqrene® 1450N from ATOFINA), and a proportion of 75% by weight of PVC (BENVIC IR047 from SOLVAY) were dissolved in a solvent consisting (in terms of weight) of MEK (80%)/hexane (15%)/water (5%), using 400 g of polymers for 4068 ml of solvent. The dissolution process was carried out at 100° C. under 1.5 bar, with stirring at 600 rpm, and took 30 min. The solution obtained was filtered at ambient temperature using a filter with 125-μm pores.

The solution was then introduced into a heated double-walled reactor at 50° C. Stirring was begun and controlled to 800 rpm, and the pressure was reduced to 600 mbar. Injection of steam (at 2 l/h) then began, and when the temperature of the reactor had reached 60° C., 1.5 l of liquid water were injected into the solution (at 15 l/h) while continuing the addition of steam (1.5 l in total, the precipitation time being 45 min) in order to distil the MEK/water azeotrope. When the temperature had reached 85° C., injection of steam was stopped, and was followed by cooling and filtration of the slurry obtained. The product after filtration was a blend in the form of powder which was dried at 50° C. at reduced pressure to constant weight. This powder consists of substantially spherical particles having an average diameter of about 400 μm.

1. Process for the manufacture of a blend based on PVC and at least one plastic, according to which:
1. the PVC and the plastic are dissolved in a common solvent;
2. joint precipitation of the PVC and of the plastic is brought about in the form of particles of blend, by injecting water as a common non-solvent into the solution;
3. the particles of blend are recovered.

2. Process according to claim 1, in which the plastic is chosen from ABS; PU, PC, PET and PS.

3. Process according to claim 1, in which one or more additives are added to the solution of PVC and of the plastic prior to the precipitation of the particles of blend.

4. Process according to claim 3, in which the additive comprises a compatibilizer for the PVC and for the plastic.

5. Process according to claim 1, in which the solvent and the non-solvent are miscible and form an azeotrope.

6. Process according to claim 1, in which the dissolution of the PVC and of the plastic takes place in the presence of a phase separator compatible with the solvent and incompatible with the non-solvent.

7. Process according to claim 1, in which the precipitation takes place in the presence of a dispersing agent.

8. Process according to claim 1, in which the non-solvent is added progressively into the solvent containing the dissolved PVC and the dissolved plastic, and the pressure is reduced progressively below atmospheric pressure during this addition of non-solvent.

9. Blend based on PVC and at least one plastic which can be obtained by a process according to claim 1, and consisting of substantially spherical particles having an average diameter (d) greater than or equal to 100 μm and smaller than or equal to 800 μm.

10. Blend according to the claim 9, characterized in that the breadth of distribution of the particles is such that at least 80% of the particles have a diameter between d−0.4 d and d+0.4 d.

11. Process according to claim 2, in which one or more additives are added to the solution of PVC and of the plastic prior to the precipitation of the particles of blend.

12. Process according to claim 11, in which the additive comprises a compatibilizer for the PVC and for the plastic.

13. Process according to claim 12, in which the solvent and the non-solvent are miscible and form an azeotrope.

14. Process according to claim 13, in which the dissolution of the PVC and of the plastic takes place in the presence of a phase separator compatible with the solvent and incompatible with the non-solvent.

15. Process according to claim 14, in which the precipitation takes place in the presence of a dispersing agent.

16. Process according to claim 15, in which the non-solvent is added progressively into the solvent containing the dissolved PVC and the dissolved plastic, and the pressure is reduced progressively below atmospheric pressure during this addition of non-solvent.
